(19) United States
(12) Patent Application Publication
(10) Pub. No.: US 2019/0149882 A1
(43) Pub. Date: May 16, 2019

(54) SYSTEMS AND METHODS OF USING TILED MULTI RESOLUTION PYRAMID IMAGE ARCHITECTURE

(71) Applicant: ZOOMLOOK LLC, New York, NY (US)

(72) Inventor: CHRISTOPHER D. HANNAN, Chester, NJ (US)

(21) Appl. No.: 16/188,447

(22) Filed: Nov. 13, 2018

Related U.S. Application Data
(60) Provisional application No. 62/585,461, filed on Nov. 13, 2017.

(51) Int. Cl. H04N 21/4728; H04N 21/2662; H04N 21/2387

(52) U.S. Cl. CPC H04N 21/4728; H04N 21/2387; H04N 21/2662

(57) ABSTRACT

A system and method for generating an interactive non-linear audio video data set consisting of pyramid image video frames derived from the original resolution of each video frame propagating to different spacial resolutions allowing for dynamic rendering on any device at any resolution and interactive depth shifting of the viewer's point of view to access any region of interest at any temporal or spatial coordinate within the motion video displayed.

### CROSS-REFERENCE TO RELATED APPLICATION

This application is based upon, and relies upon, provisional patent application Ser. No. 62/585,461, filed Nov. 13, 2018, the entire disclosure of with is incorporated herein by reference.

### BACKGROUND

### Field of the Invention

Embodiments of the present invention are generally related to a systems and methods of using tiled multi resolution pyramid image architecture. More specifically, some embodiments of the present invention relate to a system and method for generating an interactive non-linear audio video data set consisting of pyramid image video frames derived from the original resolution of each video frame propagating to different spacial resolutions allowing for dynamic rendering on any device at any resolution and interactive depth shifting of the viewer's point of view to access any region of interest at any temporal or spatial coordinate within the motion video displayed.

Some embodiments of the present disclosure are related to a system and method providing a data pathway to a signal or plurality of signals from a portable digital device for data transfer, which are then processed into multi-resolution pyramid image data and transported to a cloud server array for serving subsequent pyramid images over cellular networks.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a tiled multi-resolution pyramid image in accordance with embodiments of the present disclosure; and

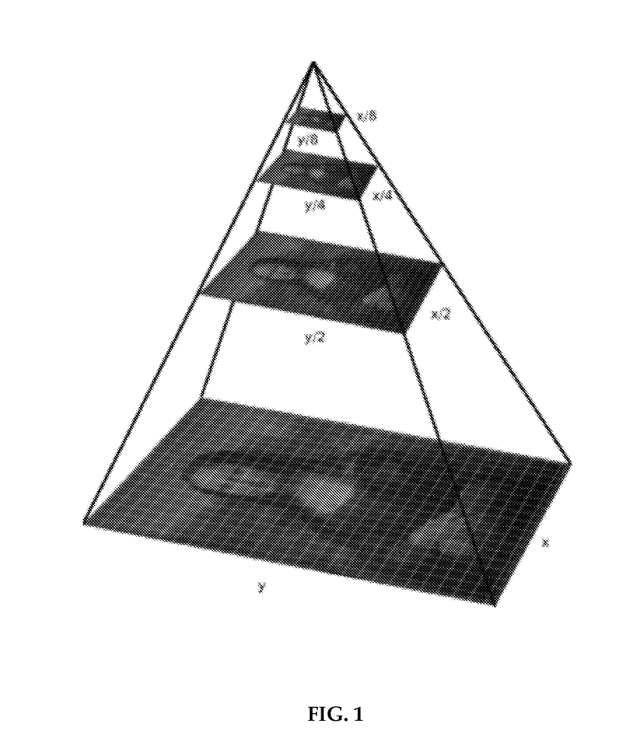

FIG. 2 depicts a functional block diagram of a cloud computing system in accordance with embodiments of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

A system in accordance with exemplary embodiments of the present disclosure may include unique and original uses and interpretations of tiled multi resolution pyramid image architecture. A tiled multi-resolution pyramid image is a data storage format for a digitally encoded image array in which the original high resolution image is served as matrix containing a number of resolution levels, wherein each level is made up of a segmented grid array containing partial image data components corresponding to different resolutions represented by planes intersecting a pyramid at different levels.

Embodiments of the present invention are generally related to a systems and methods of using tiled multi resolution pyramid image architecture. More specifically, some embodiments of the present invention relate to a system and method for generating an interactive non-linear audio video data set consisting of pyramid image video frames derived from the original resolution of each video frame propagating to different spacial resolutions allowing for dynamic rendering on any device at any resolution and interactive depth shifting of the viewer's point of view to access any region of interest at any temporal or spatial coordinate within the motion video displayed.

A system in accordance with exemplary embodiments of the present disclosure may generate an interactive non-linear audio video data set consisting of pyramid image video frames derived from the original resolution of each video frame propagating to different spacial resolutions allowing for dynamic rendering on any device at any resolution and interactive depth shifting of the viewer's point of view to access any region of interest at any temporal or spatial coordinate within the motion video displayed. Audio tracks may exhibit multitrack functions and may be either in sync with video frames or are out of sync, called dynamically through user interaction, by key frames or as background audio. The technology may not use any existing standard video codec compression or decompression standards. For example, a scriptable programmable grid layer may exist above the video layer with Z coordinate functions allowing for sprites, hotspots, buttons, multimedia links and hyperlinks to track over the temporal and spacial field at any point or throughout the entirety of the Multi-resolution Pyramid Image Data Archive to achieve a system in accordance with exemplary embodiments of the present disclosure may video.

A system in accordance with exemplary embodiments of the present disclosure is a solution to problems of universal dynamically sized content distribution. A system in accordance with exemplary embodiments of the present disclosure may prevent illegal downloading of copyrighted material, or the like. It may create new categories of interactive experiences for users, user data acquisition through nonlinear, multi-track, multi-resolution, multi-dimensional multimedia functionality and artificial intelligence.

Video technologies have evolved overtime which have increased the quality of the video experience through higher quality compression and distribution. However the main architecture of video has been consistent, providing a timeline with frames and an audio track. A system in accordance with exemplary embodiments of the present disclosure may include a deconstruction and reorganization of the video file paradigm into a flexible, dynamic and scriptable non-linear, multi-resolution, multimedia experience which can provide a passive and or interactive experience which can change at the will of the viewer based on user generated inputs while also preventing illegal downloading of the media all together due to its deconstructed image and audio capabilities and architecture.

A system in accordance with exemplary embodiments of the present disclosure may include multi-resolution pyramid image frames scriptable at any layer of depth and any point in the timeline. In some embodiments, a system may include multitrack audio and may support non-linear, narrative and first person storytelling. In some embodiments, a system may support interactive viewing with full resolution of content at any depth view fit to frame and/or may be capable of product purchase from inside the video, or the like. In some embodiments, a system may be programmable multimedia layer and support AI. In some embodiments, a system may include machine vision; machine learning; user generation data; predictive modeling; user customization, prevent download of source media file(s), and or the like.

A system in accordance with exemplary embodiments of the present disclosure may be cloud-based. Internet Technologies, apps and digital platforms use a wide array of programming languages, unique processes, proprietary source code and unique configurations making it difficult to integrate multi-resolution pyramid imaging directly into them. A system in accordance with exemplary embodiments of the present disclosure may provide a solution to this problem by moving the integral multi-resolution pyramid image generation and interactive multimedia user interface editor into a multi-node Cloud based computational storage network array whereby integration with closed systems and proprietary platforms is achieved and use of multi-resolution data sets is made universally available to mission critical business operations managed remotely through the system, or the like.

A system in accordance with exemplary embodiments of the present disclosure may include may include an autonomous cloud computing and cloud storage system which integrates externally with third party technologies. In some embodiments, a system may include a technology agnostic solution for pyramid image generation, system integration and user interface design for the utilization of multi-resolution pyramid image based data sets. Signals may be generated and sent to a system in accordance with exemplary embodiments of the present disclosure, where the signal and or a plurality of signals are converted from their original full resolution into pyramid images through a scalable network architecture of worker units which process each signal or plurality of signals, manage meta data acquisition applied through a GRID CONFIG coordinate layer related to the original signal from secondary data sources which is stored in a file in the cloud storage and also sent to a database providing search and data retrieval for integration of the single signal and or a plurality of multi-signal pyramid image data arrays located in multiple nodes within the cloud infrastructure occupying different physical regions globally.

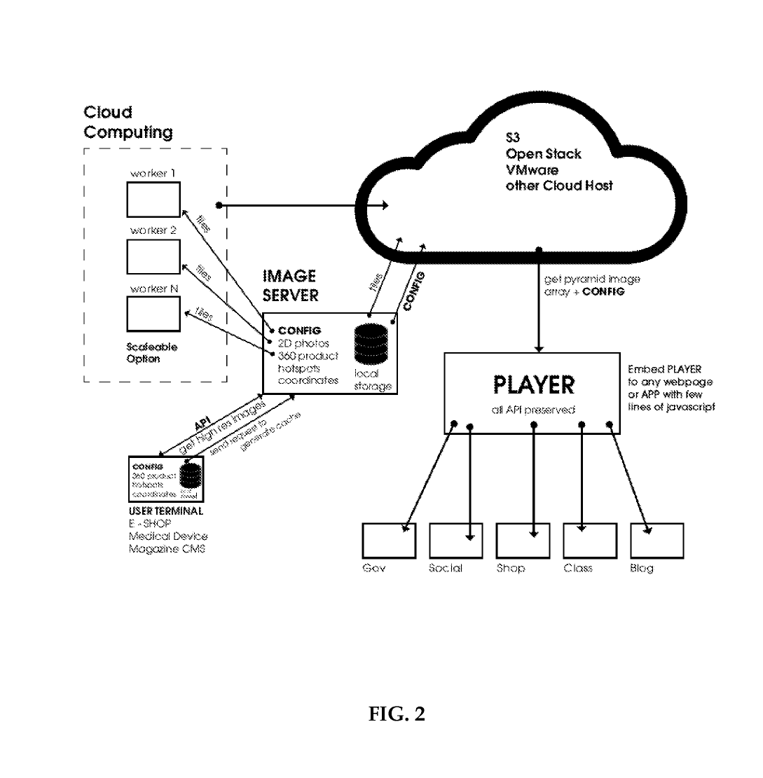

A system in accordance with exemplary embodiments of the present disclosure may include a scalable remote architecture for the processing and storage of pyramid image data sets that may provide access to remote hierarchical and relational database applications to attach metadata to pyramid image archives. In some embodiments, the system may generate a GRID GONFIG based user interface containing, for example, UI buttons, links, AI, 360, 3D, data input, geometry, annotation, interactive multimedia, animation, vectors, video, an API which integrates into third party systems, and/or the like. In some embodiments, the system may be scriptable. Referring now to FIG. 2, a functional block diagram of a cloud computing system in accordance with embodiments of the present disclosure is shown. FIG. 2 depicts an exemplary cloud-based system.

A system in accordance with exemplary embodiments of the present disclosure may be implemented with mobile devices, or the like. Cell phones and other portable digital devices may be equipped with image generating capabilities of ever increasing resolution, creating larger and larger file sizes which can become problematic for storage and sharing directly to individuals and groups over the variable limited bandwidth available to cellular networks. A system in accordance with exemplary embodiments of the present disclosure may provide a unique data pathway for users to both archive and share their photographic image archives to individuals or groups using a cloud architecture for delivery over cellular networks, and/or the like.

A system in accordance with exemplary embodiments of the present disclosure may provide a data pathway to a signal or plurality of signals from a portable digital device for data transfer, which may then be processed into multi-resolution pyramid image data and transported to a cloud server array for serving subsequent pyramid images over cellular networks. In some embodiments, a mobile device, or the like, may be connected to a cloud-based system and may generate GRID CONFIG data to classify, manipulate, script and/or integrate pyramid image output into third party systems, apps, social media, websites, VR spaces, multiplayer games, augmented reality, geo location databases and or other databases, and/or the like.

A system in accordance with exemplary embodiments of the present disclosure may include a device that may transfer high resolution images from portable hand held devices to cloud-based system of computing and storage systems, and/or the like. A system in accordance with exemplary embodiments of the present disclosure may include a data pathway between portable digital devices and a cloud-based system to program interactivity through the GRID CONFIG object layer of the pyramid image data array, or the like. In some embodiments, a system may include a contact node between cloud-based system, portable digital device(s), and third party platforms to trigger publishing to other networks such as blogs, social media, geo tagged databases, augmented reality, apps and other proprietary platforms, and/or the like. A system in accordance with exemplary embodiments of the present disclosure may include a display mechanism for multi resolution pyramid image arrays over cellular networks to personal hand held devices.

A system in accordance with exemplary embodiments of the present disclosure may be employed in medical technology, such as, for example, x-ray, MRI, CT scan, In-vitro fertilization, catheter based surgeries, open and closed cardiovascular procedures, orthopedic, neurosurgical and nerve sheath surgeries and or testing, GI surgeries and or testing, GYN surgery and or testing, Ophthalmology, Laparoscopic surgeries, Brain tumors/Gliomas, Cardio, Heart, Lung, esophageal, Orthopedic, Joint replacement, ENT, Chiroplasty, Podiatry, Tendon, Vein, Nerve repair, Burns, Oncology, Oral/orofacial, Cosmetic surgery and or testing, Equine veterinary and/or the like. In exemplary embodiments, a system for multi-resolution pyramid image technologies and related processes and technologies may have many niche market applications.

While the foregoing is directed to embodiments of the present invention, other and further embodiments of the invention may be devised without departing from the basic scope thereof. For example, although numerous embodiments having various features have been described herein, combinations of such various features in other combinations not discussed herein are contemplated within the scope of embodiments of the present invention.

I claim:

1. A method of generating and displaying a multi-resolution tiled pyramid image based interactive video comprising the steps of:
deriving from an original resolution of each video frame different spacial resolutions, and
dynamically rendering at any resolution an interactive depth shifting of a viewer's point of view to access any region of interest at any temporal or spatial coordinate within the video displayed,
whereby the end user may zoom into finer levels of resolution during playback.
